(19) United States
(12) Patent Application Publication
(10) Pub. No.: US 2016/0169477 A9
(43) Pub. Date: Jun. 16, 2016

(54) REFLECTOR FOR A LED LIGHT SOURCE AND RELATED LED LIGHTING DEVICE

(71) Applicants: Giuseppe VASTA, Novate Milanese (IT); Luca MENEGHETTI, Desio (IT)

(72) Inventors: Giuseppe VASTA, Novate Milanese (IT); Luca MENEGHETTI, Desio (IT)

(73) Assignee: KHATOD OPTOELECTRONICS SRL, Cinisello Balsamo (IT)

(21) Appl. No.: 14/670,626

(22) Filed: Mar. 27, 2015

(30) Foreign Application Priority Data
Mar. 30, 2014 (IT) MI2014A000551

(51) Int. Cl. F21V 7/00; F21K 99/00; F21V 29/70; F21V 17/00

(52) U.S. Cl. CPC F21V 7/0066; F21V 17/002; F21K 9/50; F21V 29/70; F21Y 2101/02

(57) ABSTRACT

A reflector for a LED lighting device having an LED chip, including a second opening and a main optical surface, and a first coupling for fastening the reflector to the lighting device. The reflector includes a first portion having the first coupling and a second portion which is decouplable from the first portion. The main optical surface includes a first reflective optical surface and a second reflective optical surface realized respectively internally to the first portion and internally to the second portion. The reflector also includes a second coupling which connects and fastens stably in a non permanent manner the first portion to the second portion for make continuous the main optical surface and making the first portion and the second portion replaceable respectively with different first portions or different second portions by reducing the costs and number of moulds to make reflectors.

This invention relates to a reflector for a LED light source and a related LED lighting device, in particular usable as LED spotlight or as LED light bulb.

In these years, numerous types of LEDs have been developed, and also each manufacturer of LED lighting devices requires different types and positions of the electrical contacts for power supply a given LED.

One disadvantage is that for each type of LED is therefore necessary to realize a corresponding optics and in particular a corresponding reflector for each type and position of the electrical contacts of that particular LED, consequently it is necessary to realize an extremely high number of corresponding moulds to realize each reflector.

Another disadvantage is that the cost of the mould affects greatly on the cost of each individual moulded reflector since the number of pieces realized with a particular mould will necessarily be very low.

There have been attempts to standardise and to adapt some characteristics of the LED lighting devices in order to reduce the number of different types of embodiment of the LED lighting devices.

These characteristics are not related to reflectors and optics, but which are mainly related to LEDs and the power supply thereof.

For this reason supports or adapters have been defined that allow housing the LEDs which are also known by the English term “socket”.

Despite this, currently each LED manufacturer has a own different form thereof, therefore there are about 18 different types of LEDs, with or without fastening holes, with the electrical contacts on the left or on the right, with different dimensions depending on the power and with rectangular or circular forms.

Consequently, for each type of LED, about 21 supports or adapters are required for realize lighting devices having a reflector or anyhow one optic having a particular reflective optical surface capable of realizing a determined luminous flux.

A further disadvantage is that in this manner the number of moulds is multiplied by determining an extremely high total number.

This necessarily determines the disadvantage of a considerable cost for the moulds and it fragments considerably production by reducing considerably the amortization of each mould for realizing a particular reflector for a particular type of adapter for a particular type of LED.

Purpose of the present invention is to realize a reflector for a LED light source and a related LED lighting device that allow reducing the costs of the moulds for realizing a particular reflector for a particular type of adapter or for a particular type of LED.

Another purpose is to realize a reflector for a LED lighting source which allows increasing heat dissipation resulting from the operation of the LED chips without compromising the optical efficiency.

Still another purpose is to provide a reflector for a LED light source and a related LED lighting device that are easy to realize and which have a reduced production cost.

Further purpose is to realize a reflector for a LED light source and a related LED lighting device which are economically advantageous.

These purposes according to this invention are achieved by realizing a reflector for a LED light source and a related LED lighting device as exposed in claims 1 and 12.

Further features of the invention are highlighted by the subsequent claims.

The features and advantages of a reflector for a LED light source and a related LED lighting device according to the present invention will become more clear from the following illustrative and non-limiting description, referred to the attached schematic drawings wherein:

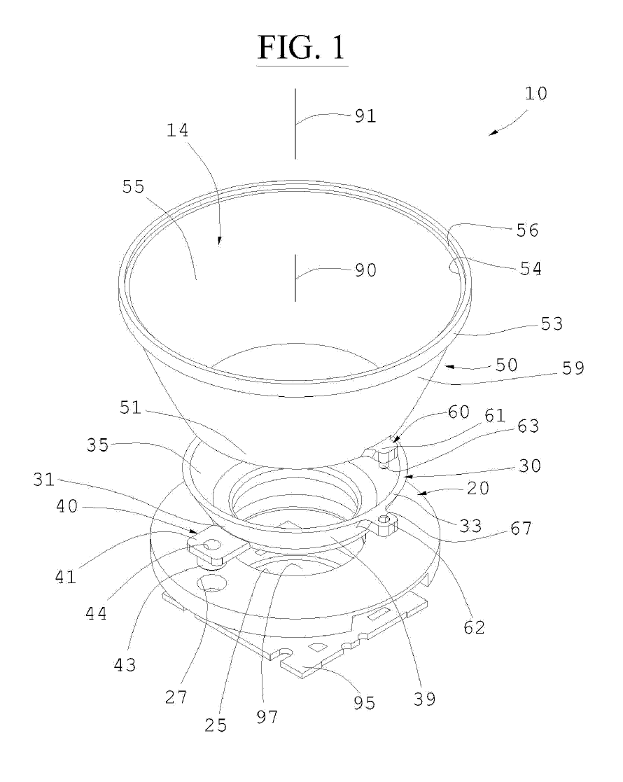

FIG. 1 is a top right side perspective exploded elevation view of a preferred embodiment of a reflector for a LED light source and a LED lighting device according to this invention;

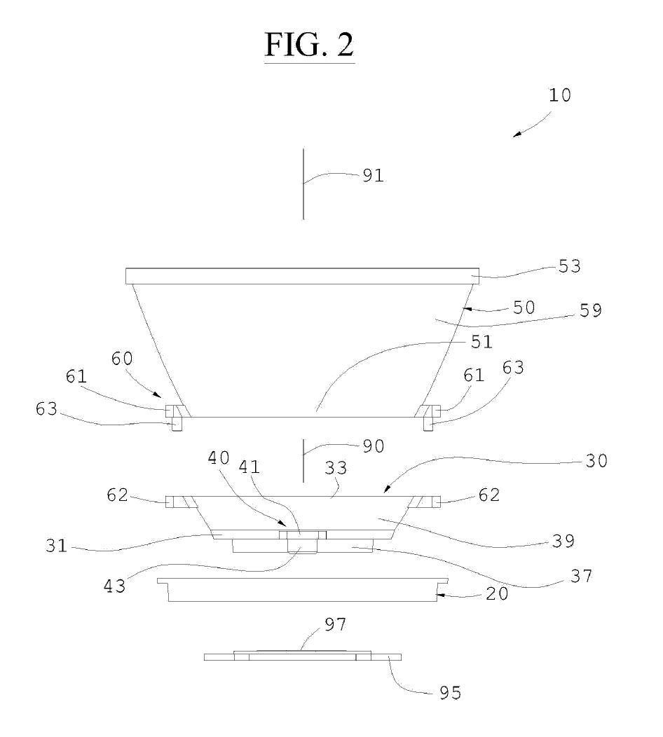

FIG. 2 is a view of FIG. 1 in front elevation:

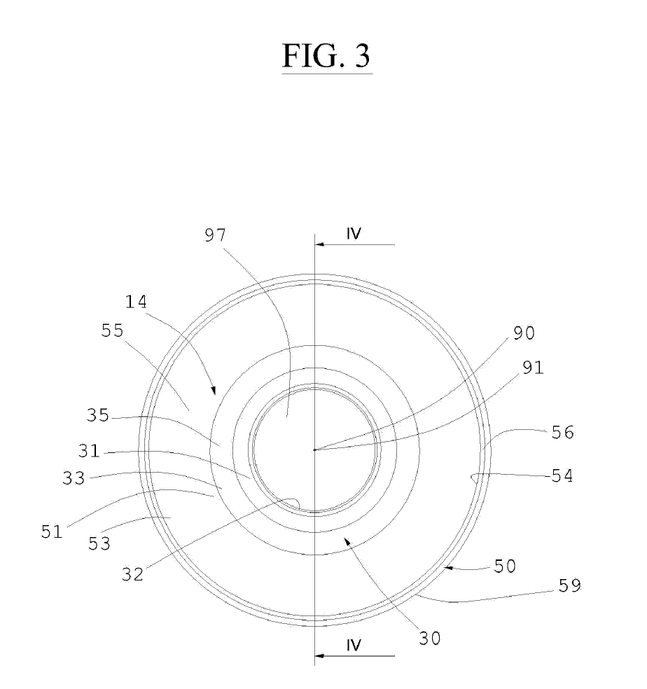

FIG. 3 is a view of FIG. 1 from above;

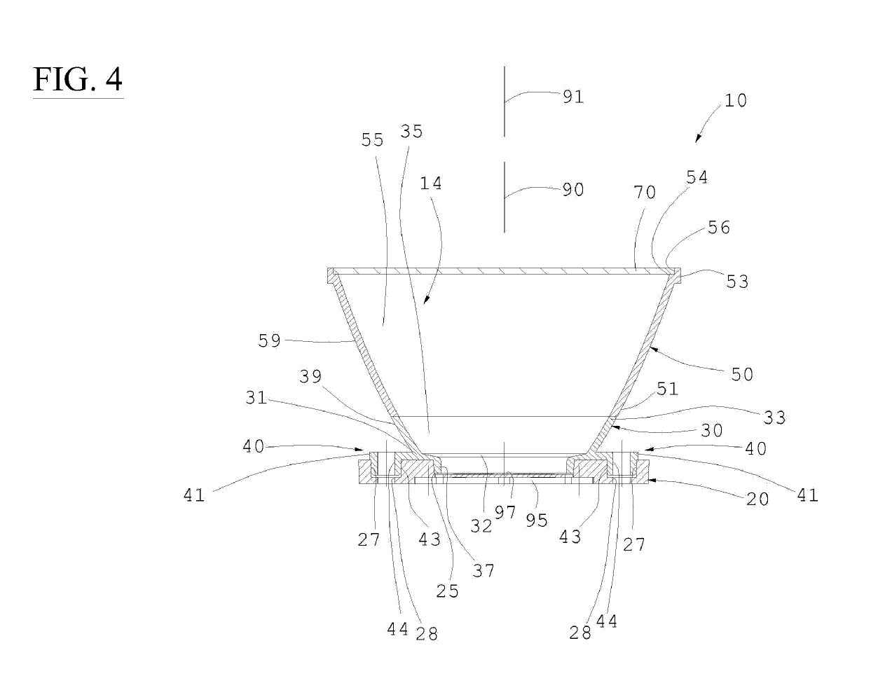

FIG. 4 is a front elevation partially sectioned view of a preferred form of embodiment of a reflector and of a LED lighting device of FIG. 3 sectioned along line IV-IV;

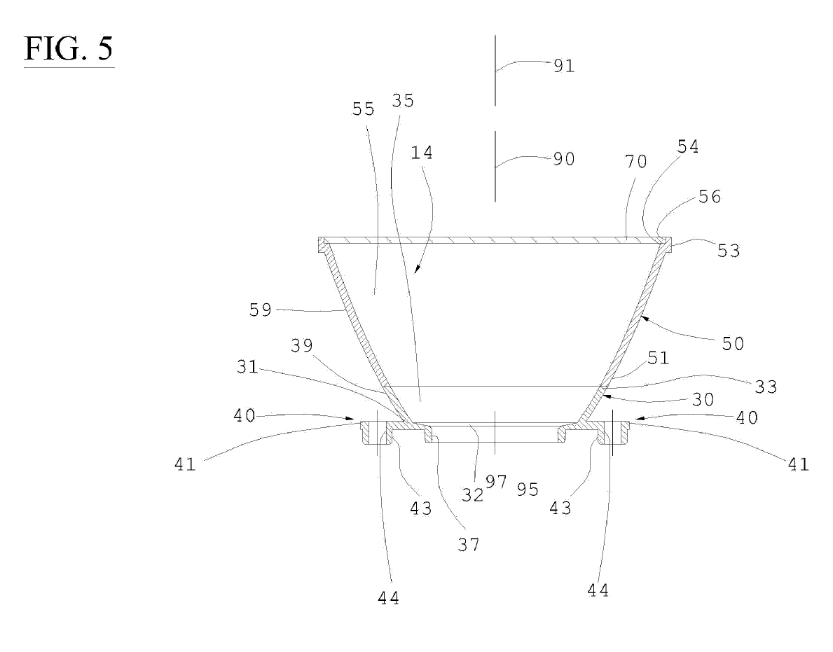

FIG. 5 is a front elevation partially sectioned view of a preferred form of embodiment of the detail of FIG. 4 according to a preferred form of embodiment of this invention;

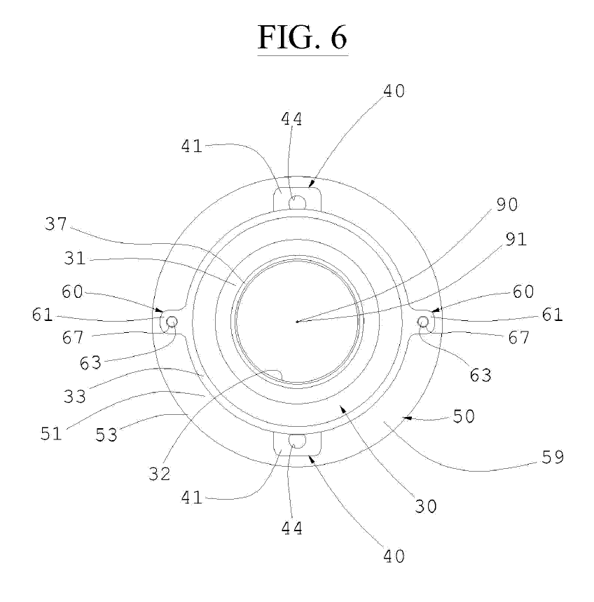

FIG. 6 is a bottom view of a preferred form of embodiment of a reflector according to the present invention;

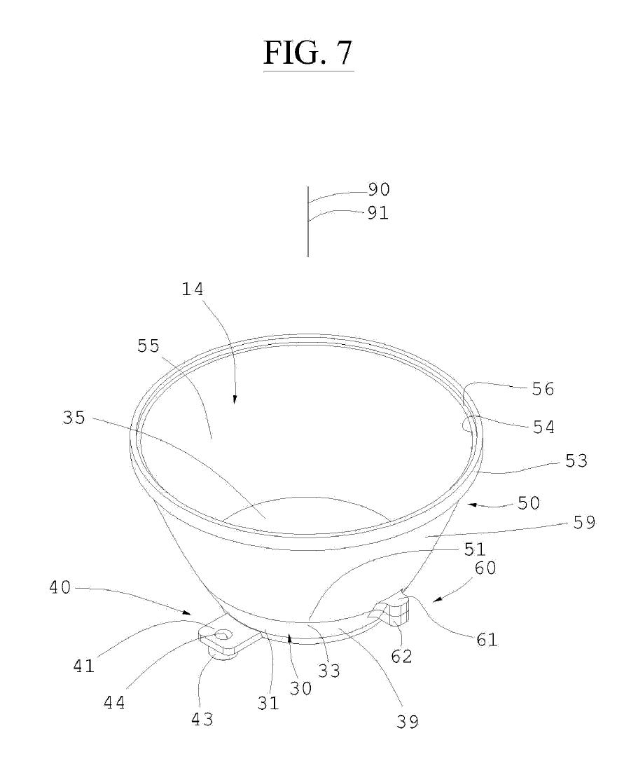

FIG. 7 is a right side perspective top elevation view of a preferred form of embodiment of a reflector according to the present invention.

With reference to the Figures, it is shown a reflector in particular axisymmetrical for a LED lighting device 110 equipped with at least one LED chip 97 in particular of COB type, the said reflector comprises a second opening 54 and a main optical surface 14 which is positionable around said at least one LED chip 97 so as to surround laterally the latter for reflect and distribute in a homogeneous manner a light flux towards said second opening 54, said reflector further comprises first coupling means 40 which are realized in proximity of a first proximal end 31 for fasten said reflector internally to said lighting device 10.

According to this invention said reflector comprises a first portion 30 provided with said first coupling means 40, and further comprises a second portion 50 which is decouplable from said first portion 30, and wherein said main optical surface 14 comprises a first reflective optical surface 35 and a second reflective optical surface 55 realized respectively internally to said first portion 30 and internally to said second portion 50.

Preferably, said reflector is a reflector for a LED chip 97 in particular of COB type.

In particular said reflector comprises a first opening 32 realized in correspondence of a first proximal end 31 and a second opening 54 realized in correspondence of a second distal end 53, and also said reflector comprises an internal cavity 12 which is provided with a main optical surface 14 preferably internal and in particular tapered towards said first proximal end 31.

In particular said main optical surface 14 is continuous and is tapered going from said second distal end 53 to said first proximal end 31.

Said reflector further comprises second coupling means 60 which connect and fasten firmly in a non permanent manner, that is in a reversible manner, said first portion 30 to said second portion 50 for make continuous said main optical surface 14 and for make replaceable said first portion 30 independently from said second portion 50 and vice versa, and in particular for make the first portion 30 and second portion 50 respectively replaceable with different first portions 30 or different second portions 50 by reducing advantageously the costs for the realization of the moulds and especially the number of moulds necessary for realize a plurality of reflectors for a plurality of different types of LED chips 97 each one of which has in particular a plurality of different connector elements 20 or supports or heat sinks for different types of LED lighting devices 10.

Advantageously, in this manner it is possible to avoid realizing entirely a new mould for realize entirely a new reflector for a new type of connector element 20 or heat sink for a new type of LED chip 97 or LED lighting device 10, by reducing to a minimum the total cost of the moulds for realizing a plurality of LED illumination devices 10 by using a minimum number of first portions 30 with corresponding first reflective optical surfaces 35 and of second portions 50 with corresponding second reflective optical surfaces 55.

Advantageously, this allows a reduction of costs for the moulds since it is possible to modify some existing moulds that are no longer usable, or little used, for realizing some first portions 30 or some second portions 50 simply by modifying the latter, by reducing significantly production costs.

Furthermore, advantageously this allows also to be capable to reuse partially the programmes of the CNC machine tools to numerical control for realizing a plurality of said first portions 30 and of said second portions having said second coupling means 60 for reduce production times and for realize a greater number of pieces for different main optical surfaces 14 so as to depreciate to a greater extent the cost of the moulds.

In particular said second coupling means 60 are used for replace said first portion 30 with at least a different first portion 30 having the same first reflective optical surface 35 and different first coupling means 40 for a different connector element 20 or support or heat sink for realizing the same main optical surface 14 without having to replace also said second portion 50.

Advantageously, this allows to realize easily a new reflector for a new type of connector element for a new LED lighting device 10 by reducing the total cost of the moulds since it will be necessary to realize only a new mould for a different first portion 30 since it will be possible to use a plurality of existing second portions 50 for different reflectors, by reducing to a minimum the production cost and increasing significantly the depreciation of the moulds for the different second portions 50.

In particular, said second coupling means 60 are used for replace said second portion 50 with at least a different second portion 50 having a different second reflective optical surface 55 for realizing a different main optical surface 14 for a determined type of LED chip 97 having determined contacts of power supply without having to replace also said first portion 30.

Advantageously, this allows to easily realize a new reflector having a different main optical surface 14 by reducing the total cost of the moulds since it will be necessary to realize only a new mould for a different second portion 50 having a different second reflective optical surface 55 since it will be possible to use a plurality of existing first portions 50 for different reflectors, by reducing to a minimum the production cost and increasing significantly the depreciation of the moulds for the different first portions 30.

In particular, according to this invention said main optical surface 14 is therefore divided into at least two parts, that is, said first reflective optical surface 35 and said second reflective optical surface 55 which are realized on corresponding separate portions, that is, said first portion 30 and said at least second portion 50, for realize the same main optical surface 14 for a different LED chip 97 type, having in particular a different size or different positions of the power supply contacts, by simply realizing a different first portion 30 having different first coupling means 40 for different types of connector elements 20 or supports, or different types of heat sinks for said LED chip 97.

In other words, said first portion 30 and said second portion 50 are two separate and distinct components which also are mutually couplable and fastenable in a non permanent manner through said second coupling means 60 for make interchangeable and therefore replaceable said first portion 30 with a different first portion 30 independently from said second portion 50 and vice versa, advantageously for use said first portion 30 and second portion 50 for realize a plurality of different reflectors for a plurality of different types of LED lighting devices 10 or for different types of supports 20 or for different heat sinks or for different LED chips 97 types.

Advantageously, said first portion 30 and second portion 50 through said second coupling means 60 allow therefore the realization in a very simple manner a plurality of main different optics 14 by only realizing a different replaceable second portion 50, and therefore interchangeable with said first portion 30 for the presence of said second coupling means 60 which allow a reversible fastening, that is, not permanent.

Advantageously, this allows to realize a plurality of reflectors by using a reduced number of first portions 30 and second portions 50 and by reducing therefore also the total cost of the moulds.

In this manner, it is in fact possible to avoid realizing a mould dedicated for each reflector having a predetermined main optical surface 14 and predetermined first coupling means 40, by allowing advantageously therefore to reduce the production cost of each reflector since it is possible to use a first portion 30, having a predetermined first reflective optical surface 35 for realize a plurality of different main optical surfaces 14, in coupling with different second portions 50 each having a different compatible second reflective optical surface 55.

Advantageously, it is also possible to use a second portion 50 having different second reflective optical surfaces 55 for realize a plurality of different main optical surfaces 14 in coupling with different first portions 30 each having different first coupling means 40 for different types of connector elements 20 or supports or for different types of heat sinks for different LED chips 97.

Advantageously, said first portion 30 and said second portion both having said second coupling means 60, allow to reduce the overall production costs of a plurality of reflectors having different first coupling means 40 and different main optical surfaces 14, since they allow to realize even small series without necessarily having a minimum number of pieces too much high for depreciate the cost of the moulds.

Preferably said first portion 30 being couplable with at least a second portion 50 for define said main optical surface 14 preferably continuous which is formed by said first reflective optical surface 35 and said second reflective optical surface 55.

Advantageously, in this manner said main optical surface 14 is preferably continuous and easily modifiable without necessarily having to fully realize a new reflector.

Advantageously, this also allows to reduce to the minimum the number of pieces in stock since it allows to realize a plurality of different reflectors having, for example, different luminous fluxes with corresponding different emission angles simply by replacing said second portion 50 with a different having a different main optical surface 14.

Preferably said first portion 30 is provided with a symmetry axis 90 and further said second more external portion 50 is provided with a symmetry axis 91, also said first portion 30 and said second portion 50 are mutually couplable through said second coupling means 60 so that the corresponding symmetry axes 90 and 91 result mutually coincident and in particular also coincident with a symmetry axis of said LED chip 97 which is in particular mounted on an electronic board 97.

Preferably said second coupling means 60 are made integral respectively with said first portion 30 and with said second portion 50, also in particular said second coupling means 60 are realized in one single piece respectively with said first portion 30 and with said second portion 50 preferably, respectively, in proximity of a distal end 33 of said first portion 30 and in proximity of a proximal end 51 of said second portion 50, also said second coupling means 60 are preferably provided with male/female portions.

Advantageously, this allows to reduce the number of pieces and to reduce further the cost of the moulds, since it is possible to modify and even reuse moulds no longer in use with small machining at the CNC tool machines.

Advantageously, said first optical portion 30 being provided with said first coupling means 40 and also being in particular integrated with said second coupling means 60 besides to the optical function that allows to partially reflect the luminous rays of said at least one LED chip 97, said first optical portion 30 also therefore performs the function of adapter that allows to have a universal connector that allows to couple to the same a plurality of second portions 50 for realize a plurality of main different optics 14 without necessarily having to fully realize whole new moulds for whole new reflectors.

In particular said first portion 30 is therefore a universal adapter for a plurality of second portions 50.

Preferably said second coupling means 60 are external to said first reflective optical surface 35 and to said second reflective optical surface 55 for not to interfere with the same and for advantageously avoid a reduction of the optical efficiency of said reflector.

Preferably said second coupling means 60 extend externally in a radial direction with respect to said first portion 30 and with respect to said second portion 50 not to reduce the optical efficiency of said reflector.

In particular said second coupling means 60 are radially projecting with respect to corresponding external surfaces 39 and 59 of said first portion 30 and of said second portion 50.

Preferably said second coupling means 60 comprise at least a couple of elements 61 and 62, in particular at least two couples of elements 61 and 62, each of which comprises corresponding couplings 67 and 63 realized respectively on said first portion 30 and on said second portion 50 or vice versa, each coupling 67 and 63 is selected preferably between a male/female coupling, a pin/hole coupling, bayonet coupling, or a screw coupling or their similar.

Preferably each element 61 is radially protruding and in particular integrated with said external surface 59 of said second portion 50 preferably in proximity of said first proximal end 51 of said second portion 50, and also each element 62 is radially protruding and in particular integrated with said external surface 39 of said first portion 30 preferably in proximity of said second distal end 33 of said first portion 30, or vice versa.

Preferably each coupling 67 and 63 of each couple of elements 61 and 62 is a male/female coupling such as in particular a coupling of a pin 63 preferably pierced which is realized on a corresponding element 61 and also which it is insertable into a corresponding hole 67 realized in a corresponding element 62, or vice versa.

Advantageously, this makes easy the realization of said first portion 30 and said second portion 50, by obtaining likewise a stable fastening thereof and at the same time releasable.

In particular said second coupling means 60 are releasable fastening means and in particular of the elastic type.

Preferably said first coupling means 40 and said second coupling means 60 are mutually partially integrated for bind stably in a reversible manner said first portion 30 to said second portion 50 and for connect preferably the same to a connector element 20 or to a support or to a heat sink for said chip 97.

Preferably said second coupling means 60 are at least partially integrated with said first coupling means 30 for fasten with a reduced number of fastening elements said first portion 30 and said second portion 50 simultaneously to a connector element 20 or to a support or to a heat sink, advantageously reducing to a minimum the number of fastening elements such as, for example, a plurality of fastening screws, not shown, in particular with only two fastening screws.

In particular said second coupling means 60 and said first coupling means 40, which are at least mutually partially integrated, comprise in particular a plurality of couplings formed respectively by a series of portions 63 in particular a plurality of pins 63, having central holes which are realized mutually coaxially and which extend along a direction parallel to said symmetry axis 90, furthermore, each series of pierced portions 63 is projecting externally with respect to the external surfaces of said first portion 30 and of said second portion 50 for not to interfere with the corresponding reflective optical surfaces 35 and 55, also preferably the pierced pins 63 of each series of pierced pins 63 are mutually insertable while maintaining free a central hole in particular for the passage of a corresponding fastening screw, not shown.

Preferably said first coupling means 40 are partially realized on said first portion 30 in particular in proximity of said first end 31 of said first portion 30 for allow fastening of said reflector to a connector element 20 and/or to a heat sink and/or to an internal housing of said lighting device 10, not shown in the figures, and in particular said first coupling means comprise at least two portions 41 projecting externally from an external surface 39 and also each portion 41 comprises in particular a hole 44 for fastening to a connector element 20 or to a heat sink, not shown, and also each portion 41 preferably comprises also a male/female coupling selected in particular among a pin 43 provided with said hole 44, or a portion of a bayonet fitting or screw coupling or their similar.

Preferably said first coupling means 30 also allow the connection of said reflector to a support, such as a support rail preferably of metal, not shown, or in particular to a connector element 20 for connecting said reflector to a heat sink for said LED chip 97.

In particular said first portion 30 allows a simple fastening to a support or to a heat exchanger heat sink in particular through only two screws and allows the use with different LED chips 97 types having the same surface overall dimensions, that is, having in particular a diameter or a side included between 7 mm and 50 mm and in particular included between 7 and 35 mm.

Advantageously, said first coupling means 40 also allows to maintain said electronic board 95 on which is mounted said LED chip 97 preferably without having to fasten the same to a housing.

Advantageously, in this manner, it is possible to allow fastening in position said reflector in a housing, not shown, of a LED lighting device, by allowing at the same time to keep in position said LED chip 97 without having to fasten the same to said housing.

Preferably said first portion 30 comprises a substantially tubular portion 37 provided with a reflective surface which is continuous with said first reflective optical surface 35 and, further, which extends more externally with respect to said first proximal end 31 in particular along a longitudinal direction substantially parallel to said symmetry axis 90 so as to continue said first opening 32, for increase the luminous efficiency of said at least one LED chip since it allows to partially reflect a luminous flux which is very angled and that it would not otherwise be re-directed towards said second opening 54.

Preferably said at least one LED chip 97 is a LED chip including a plurality of LEDs, and in particular said LED chip 97 is of COB type.

Preferably said first portion 30 is realized preferably with a thermally conductive material such as in particular a metallic material preferably selected between aluminium or alloys thereof or other metal or low density metal alloy such as zinc or steel alloys or a polymeric material resistant to high temperatures, for example above 150°, and preferably loaded with thermally conductive powders such as in particular oxides, furthermore in particular said first portion 30 comprises a plurality of fins realized on an external surface 39 thereof.

Advantageously, this allows increasing heat dissipation of said LED lighting device 10.

In particular said main optical surface 14 being divided into a plurality of reflective optical surface, such as in particular said first reflective optical surface 35 and said second reflective optical surface 55, which are realized on two distinct portions and separate portions, hence in particular on said first portion 30 and on said second portion, allows to realize these latter with different materials for maximising the mechanical characteristics of first portion 30 and the optical characteristics of said second portion, by reducing in the same time the cost of materials.

In particular said first portion 30 is realized with a polymeric material having in particular high mechanical characteristics and a high resistance to temperature, while said second portion 50 is realized with a polymeric material for optical applications for maximise the optical efficiency.

Preferably said first reflective optical surface 35 and said second reflective optical surface 55 define a surface having a substantially parabolic or elliptical or hyperbolic section and/or combinations thereof, for have a main optical surface 14 with different luminous fluxes for create different LED lighting devices 10.

According to another aspect of this invention it is provided a LED lighting device 10 comprising at least one LED chip 97 in particular of COB type and at least one corresponding reflector for said LED chip 97 according to any form of embodiment or variant of the previously described type.

Preferably said at least one LED chip 97 are at least two LED chips 97 and also said at least one reflector are at least two reflectors having collectively at least two first portions 30 and at least two second portions 50 of which each reflector comprises a first portion 30 and a second portion 50, said at least two first portions 30 are at least mutually partially integrated and also said at least two second portions 50 are at least mutually partially integrated, for reducing assembly times and for reducing the number of components, by allowing also to be capable of realizing a plurality of different types of LED lighting devices 10 for different types of LED chips 97 having different types of reflectors by reducing to a minimum the number of different first portions 30 and of different second portions 50, by obtaining therefore a reduced total cost for the moulds.

Preferably said LED lighting device 10 comprises a heat sink, not shown, which is placed in thermal contact with said at least one LED chip 97 through direct contact or through a double-sided conductive layer, and in particular said heat sink is placed in thermal contact also with said first portion 30.

Preferably said first portion 30 is realized preferably with a thermally conductive material such as in particular a metallic material preferably selected among aluminium or alloys thereof or other metal or low density metal alloy such as zinc or steel alloys or a polymeric material loaded in particular with thermally conductive powders such as in particular oxides, in addition in particular said first portion 30 comprises a plurality of fins realized on an external surface 39 thereof.

Advantageously this allows increasing the heat dissipation of said LED lighting device 10.

Preferably said LED lighting device 10 comprises a connector element 20 in particular substantially shaped as a disk having a central hole 25 for surround a corresponding LED chip 97, and also having two holes 27 positioned symmetrically on two diametrically opposite ends respect to said central hole 25 which realize couplings for said first coupling means 40 which are partially realized in proximity of a proximal end 31 of said first portion 30 and partially on said connector element 20 or on a heat sink which is couplable to said electronics board 95.

In particular said at least two holes 27 are provided with corresponding centres which are distant preferably 25 mm or 60 mm for allow fastening in corresponding holes of pierced metal bars such as, for example, bars of DIN type, which have a plurality of holes mutually equidistant by a distance included between 25 mm or 60 mm depending on the type.

In particular said first portion 30 is realized with a polymeric material having in particular high mechanical characteristics and a high resistance to temperature, while the second portion 50 is realized in a polymeric material for optical applications for maximise the optical efficiency.

Preferably each LED chip 97 has a power of at least 1 W in particular of at least 3 W.

Preferably said LED lighting device 10 comprises at least one filter and/or at least one lens 70 which is positioned in a housing 56 of said second portion 50 in proximity of said second distal opening 54, said lens 70 is preferably coloured and also has an external surface, preferably more internal and closer to said LED chip 97, which is smooth or knurled, or having a plurality of microspheres or optical of Fresnel type for filter advantageously the light flux produced by said at least one LED chip 97.

Preferably said at least one filter and/or at least one lens comprises a lens or a filter having a flower, or heart or flag or leaf formed contour or other similar forms having also an aesthetic function and having in particular a form substantially planar and which preferably extends orthogonally to said symmetry axis 90 within said corresponding housing 56.

It has thus been seen that a reflector for a LED light source and a related LED lighting device according to the present invention achieve the purposes highlighted previously.

The reflector for a LED light source and the related LED lighting device of the present invention thus conceived are susceptible to numerous modifications and variations, all falling within the same inventive concept.

Moreover, in practice, the materials used, as well as their dimensions and components, may be any depending on the technical requirements.

1. Reflector for a LED lighting device (10) provided with at least one LED chip (97), said reflector comprises a second opening (54) and a main optical surface (14) which is positionable around said at least one LED chip (97) so as to surround laterally the same for reflect and distribute in a homogeneous manner a luminous flux towards said second opening (54), further said reflector comprises first coupling means (40) which are realized in proximity of a first proximal end (31) for fasten said reflector internally to said lighting device (10), characterized in that said reflector comprises a first portion (30) provided with said first coupling means (40) and also comprises a second portion (50) which is decouplable from said first portion (30), and wherein said main optical surface (14) comprises a first reflective optical surface (35) and a second reflective optical surface (55) realized respectively internally to said first portion (30) and internally to said second portion (50), said reflector further comprises second coupling means (60) which connect and firmly fasten in a non permanent manner said first portion (30) to said second portion (50) for make continuous said main optical surface (14) and for make replaceable said first portion (30) independently from said second portion (50) and vice versa, and in particular for make said first portion (30) and said second portion (50) respectively replaceable with different first portions (30) or different second portions (50) by reducing advantageously the costs for the realization of moulds and especially the number of the moulds needed for realizing a plurality of reflectors for a plurality of different types of LED chips (97) each of which has in particular a plurality of different connector elements (20) or supports, or heat sinks for different types of LED lighting devices (10).

2. Reflector according to claim 1, characterized in that said reflector comprises a first opening (32) realized in correspondence of a first proximal end (31) and a second opening (54) realized in correspondence of a second distal end (53), and also said reflector comprises in internal cavity (12) which is provided with said main optical surface (14) preferably internal and in particular tapered towards said first proximal end (31), in particular said main optical surface (14) is continuous and it is tapered going from said second distal end (53) to said first proximal end (31).

3. Reflector according to claim 1, characterized in that said second coupling means (60) are made integral respectively with said first portion (30) and with said second portion (50), also in particular said second coupling means (60) are realized in one single piece respectively with said first portion (30) and with said second portion (50), respectively preferably in proximity of a distal end (33) of said first portion (30) and in proximity of a proximal end (51) of said second portion (50).

4. Reflector according to claim 1, characterized in that said second coupling means (60) are external to said first reflective optical surface (35) and external to said second reflective optical surface (55) for not interfere with the same and for avoid advantageously a reduction of the optical efficiency of said reflector, preferably said second coupling means (60) extend externally in a radial direction with respect to said first portion (30) and with respect to said second portion (50) for avoid a reduction of the optical efficiency of said reflector, in particular said second coupling means (60) are radially projecting with respect to corresponding external surfaces (39) and (59) of said first portion (30) and of said second portion (50).

5. Reflector according to claim 1, characterized in that said second coupling means (60) comprise at least one couple of elements (61) and (62) in particular at least two couplings of elements (61) and (62), each of which comprises corresponding couplings (67) and (63) realized respectively on said first portion (30) and on said second portion (50) or vice versa, each coupling (67) and (63) is preferably selected between a male/female coupling, pin/hole coupling, bayonet coupling, screw coupling or their similar.

6. Reflector according to claim 5, characterized in that each element (61) is radially protruding, and in particular integrated with said external surface (59) of said second portion (50) preferably in proximity of said first proximal end (51) of said second portion (50), and also each element (62) is radially protruding and in particular integrated with said external surface (39) of said first portion (30) preferably in proximity of said second distal end (33) of said first portion (30), or vice versa.

7. Reflector according to claim 5, characterized in that each coupling (67) and (63) of each couple of elements (61) and (62) is a male/female coupling such as in particular a pin coupling (63) preferably pierced which is realized on a corresponding element (61) and also which is insertable into a corresponding hole (67) realized in a corresponding element (62), or vice versa.

8. Reflector according to claim 1, characterized in that said first coupling means (40) and said second coupling means (60) are mutually partially integrated for bind stably in a reversible manner said first portion (30) to said second portion (50) and for connect preferably the same to a connector element (20) or to a support or to a heat sink to said chip (97).

9. Reflector according to claim 8, characterized in that said second coupling means (60) and said first coupling means (40), which are at least mutually partially integrated, comprise in particular a plurality of couplings formed respectively by a series of portions (63), in particular a plurality of pins (63), having central holes which are realized mutually coaxially and which extend along a direction parallel to said symmetry axis (90), also each series of pierced portions (63) is projecting externally with respect to the external surfaces of said first portion (30) and of said second portion (50) for not to interfere with the corresponding reflective optical surfaces (35) and (55), further preferably the pierced pins (63) of each series of pierced pins (63) are mutually insertable while maintaining free a central bore in particular for the passage of a corresponding fastening screw.

10. Reflector according to claim 1, characterized in that said first coupling means (40) are partially realized on said first portion (30) in particular in proximity of said first end (31) of said first portion (30) for allow fastening of said reflector to a connector element (20) and/or to a heat sink and/or to an internal housing of said lighting device (10), and in particular said first coupling means comprise at least two portions (41) projecting externally from an external surface (39) and, further, each portion (41) comprises in particular a hole (44) for fastening to a connector element (20) or to a heat sink, and also each portion (41) comprises preferably also a male/female coupling selected in particular among a pin (43) provided with said hole (44) or a portion of a bayonet fitting or screw, or their similar.

11. Reflector according to claim 1, characterized in that said first portion (30) comprises a substantially tubular portion (37) provided with a reflective surface which is continuous with said first reflective optical surface (35) and further which extends more externally with respect to said first proximal end (31) in particular along a longitudinal direction substantially parallel to said symmetry axis (90) for continue said first opening (32).

12. LED lighting device 10 comprising at least one LED chip (97) in particular of COB type and at least one corresponding reflector for said LED chip (97) according to claim 1.

13. LED lighting device 10 according to claim 12, characterized in that said at least one LED chip (97) are at least two LED chips (97) and also said at least one reflector are at least two reflectors having collectively at least two first portions (30) and at least two second portions (50) of which each reflector comprises a first portion (30) and a second portion (50), said at least two first portions (30) are at least mutually partially integrated and also said at least two second portions (50) are at least mutually partially integrated for reduce assembly times and the number of components.

14. LED lighting device (10) according to claim 12, characterized in that it comprises a heat sink which is placed in thermal contact with said at least one LED chip (97) through direct contact or through a double-sided conductive layer, and in particular said heat sink is placed in thermal contact also with said first portion (30).

15. LED lighting device (10) according to claim 12, characterized in that said first portion (30) is realized preferably with a thermally conductive material such as in particular a metallic material preferably selected between aluminium or alloys thereof or other metal or low density metal alloy such as zinc or steel alloys, or a polymeric material resistant to high temperatures and preferably loaded with thermally conductive powders such as in particular oxides, also in particular said first portion (30) comprises a plurality of fins realized on an external surface (39) thereof.

16. LED lighting device (10) according to claim 12, characterized in that it comprises a connector element (20) in particular substantially shaped as a disk and having a central hole (25) for surround a corresponding LED chip (97) and further having two holes (27) positioned symmetrically on two diametrically opposite ends respect to said central hole (25) which realize couplings for said first coupling means (40) which are partially realized in proximity of a proximal end (31) of said first portion (30) and partially on said connector element (20) or on a heat sink which is coupled to said electronic board (95).

17. LED lighting device (10) according to claim 12, characterized in that said first portion (30) is realized with a polymeric material having in particular high mechanical characteristics and a high resistance to temperature, while said second portion (50) is realized with a polymeric material for optical applications for maximise optical efficiency.

18. LED lighting device (10) according to claim 12, characterized in that it comprises at least one filter and/or at least one lens (70) which is positionable in a housing (56) of said second portion (50) in proximity of said second distal opening (54), said lens (70) is preferably coloured and also has an external surface which is smooth or knurled or having a plurality of microspheres for advantageously filter the light flux produced by said at least one LED chip (97).
